(19) United States
(12) Patent Application Publication
(10) Pub. No.: US 2020/0318210 A1
(43) Pub. Date: Oct. 8, 2020

(54) A COATED STEEL SUBSTRATE

(71) Applicant: ArcelorMittal, Luxembourg (LU)

(72) Inventors: Carlos LALIENA IRANZO, Oviedo, Asturias (ES); Marcos PEREZ RODRIGUEZ, Cangas Del Narcea, Asturias (ES)

(21) Appl. No.: 16/768,567

(22) PCT Filed: Dec. 11, 2018
(86) PCT No.: PCT/IB2018/059869

§ 371 Date: May 29, 2020

(30) Foreign Application Priority Data
Dec. 19, 2017 (IB) PCT/IB2017/058106

(51) Int. Cl. C21D 1/70; C08K 3/04; C22C 38/02; C08K 3/30; C08K 3/22; C09D 1/02; C09D 7/40; C09D 7/61; C22C 38/04; C22C 38/34; C22C 38/08; C22C 38/22; C22C 38/46; C22C 38/50; C21D 8/02

(52) U.S. Cl. CPC C21D 1/70; B82Y 30/00; C22C 38/02; C08K 3/30; C08K 3/22; C09D 1/02; C09D 7/69; C09D 7/70; C09D 7/61; C22C 38/04; C22C 38/34; C22C 38/08; C22C 38/22; C22C 38/46; C22C 38/50; C21D 8/0226; C21D 8/0284; C08K 2003/3081; C08K 2003/2227; C08K 3/042

(57) ABSTRACT

A coated steel substrate including a coating including nanographite having a lateral size between 1 and 60 μm and a binder including sodium silicate or a binder including aluminum sulfate and an additive being alumina, wherein the steel substrate has the following compositions in weight percent: 0.31≤C≤1.2%, 0.1≤Si≤1.7%, 0.15≤Mn≤3.0%, P≤0.01%, S≤0.1%, Cr≤1.0%, Ni≤1.0%, Mo≤0.1%, and on a purely optional basis, one or more elements such as Nb≤0.05%, B≤0.003%, Ti≤0.06%, Cu≤0.1%, Co≤0.1%, N≤0.01%, V≤0.05%, the remainder of the composition being made of iron and inevitable impurities resulting from the elaboration and a method for the manufacture of the coated steel substrate.

The present invention relates to a steel substrate coated with a coating including nanographite, having a specific lateral size, and a binder, and to a method for the manufacture of this coated steel substrate. It is particularly well suited for the steel industry.

### BACKGROUND

In the steel route production, after the steel making step, the steel is casted in the continuous casting. Semi-products, such as slabs, billets or blooms, are thus obtained. Usually, the semi-products are reheated at high temperature in a reheating furnace to dissolve the precipitates formed during the continuous casting and to obtain a hot workability. They are then descaled and hot-rolled. However, during the reheating step, semi-products can have some problems such as oxidation in a form of scale or decarburization.

To overcome these problems, it is known to deposit a coating on the semi-products, the coating allowing a good protection during the reheating step.

The patent application CN101696328 discloses a protective coating for a surface of a steel piece in order to prevent the surface from oxidation and decarburization at high temperature and, improve hardness and abrasion resistance and ultimately increase the overall service life of the steel workpiece, for the case of oxidation and decarburization of a surface (substrate) of a steel workpiece at high temperature, and the surface oxidation decarburization under the oxidizing atmosphere during heat treatment, forging, hot rolling, roll forming heating, particularly for the case that the steel workpiece is easy to be oxidized and decarbonized at high temperature in a heat treatment, leading to reduction in carbon atoms and carbon content, and the change in the surface (substrate) microstructure results in a reduced hardness, a reduced abrasion resistance and a short overall service life.

In this patent application, the coating has a composition of: graphite, water glass and surface penetrant, in which a volume ratio of the graphite to sodium silicate is 1:3 to 1:7, and the surface penetrant constitutes 0.05% to 0.15% by volume of the coating. However, there is no mention of the coating adhesion properties.

### BACKGROUND

An object of the present invention is to provide a steel substrate comprising a protection coating during the reheating that adheres well onto the steel.

The present invention provides a coated steel substrate comprising a coating comprising nanographite having a lateral size between 1 and 60 μm and a binder including sodium silicate or a binder including aluminum sulfate and an additive being alumina, wherein the steel substrate has the following compositions in weight percent:

0.31≤C≤1.2%,

0.1≤Si≤1.7%,

0.15≤Mn≤3.0%,

P≤0.01%,

S≤0.1%,

Cr≤1.0%,

Ni≤1.0%,

Mo≤0.1%,
and on a purely optional basis, one or more elements such as

Nb≤0.05%,

B≤0.003%,

Ti≤0.06%,

Cu≤0.1%,

Co≤0.1%,

N≤0.01%,

V≤0.05%,
the remainder of the composition being made of iron and inevitable impurities resulting from the elaboration.

Methods for the manufacture of a coated steel substrate and of a hot rolled steel product also are provided as is the use of a hot rolled steel product.

### BRIEF DESCRIPTION OF THE DRAWINGS

To illustrate the invention, various embodiments and trials of non-limiting examples will be described, particularly with reference to the following Figure:

FIG. 1 illustrates an example of coated steel substrate according to the present invention.

FIG. 2 illustrates an example of one nanographite flake according to the present invention.

### DETAILED DESCRIPTION

Other characteristics and advantages of the invention will become apparent from the following detailed description of the invention.

The invention relates to a coated steel substrate comprising a coating comprising nanographite having a lateral size between 1 and 60 μm and a binder including sodium silicate or a binder including aluminum sulfate and an additive being alumina, wherein the steel substrate has the following compositions in weight percent:

0.31≤C≤1.2%,

0.1≤Si≤1.7%,

0.15≤Mn≤3.0%,

P≤0.01%,

S≤0.1%,

Cr≤0.5%,

Ni≤0.5%,

Mo≤0.1%,
and on a purely optional basis, one or more elements such as

Nb≤0.05%,

B≤0.003%,

Ti≤0.06%,

Cu≤0.1%,

Co≤0.1%,

N≤0.01%,

V≤0.05%,
the remainder of the composition being made of iron and inevitable impurities resulting from the elaboration.

Without willing to be bound by any theory, it seems that a coating comprising nanographite having a lateral size between 1 and 60 μm and a binder including sodium silicate or a binder including aluminum sulfate and an additive being alumina on a steel substrate having the above specific steel composition well adheres on the steel substrate so that the steel substrate is well protected. The inventors have found that not only the steel composition but also the nature of coating plays an important role on the coating adhesion. Indeed, if the coating does not adhere on the steel substrate, there is an important risk that the coating cracks and detaches exposing the steel substrate to among others oxidation and/or decarburization.

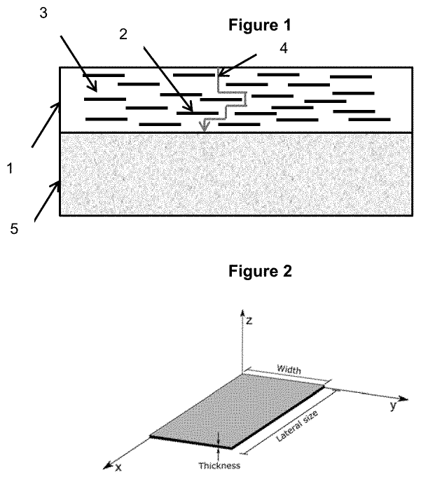

As illustrated in FIG. 1, it is believed that in the coating (1) nanographite flake (2) having this specific lateral size are well dispersed into the binder (3) in a form of tortuous path (4). Thus, problems such as the oxidation and decarburization are avoided. Finally, it is believed that the use of nanographites having the lateral size between 1 and 60 μm allows for a cluster including a large amount of nanographite flakes resulting in a narrower space between each nanographite particle. Thus, the tortuous path is more difficult to cross allowing for a high protection of the steel substrate (5).

Regarding the chemical composition of the steel, preferably, the C amount is between 0.31 and 1.0% by weight.

Preferably, the Mn amount is between 0.15 and 2.0% by weight, more preferably between 0.15 and 1.5% by weight and advantageously between 0.15 and 0.7% by weight.

Advantageously, the amount of Cr is below or equal to 0.3% by weight.

Preferably, the amount of Ni is below or equal to 0.1% by weight.

Advantageously, the amount of Mo is below or equal to 0.1%.

FIG. 2 illustrates an example of nanographite according to the present invention. In this example, the lateral size means the highest length of the nanoplatelet through the X axis and the thickness means the height of the nanoplatelet through the Z axis. The width of the nanoplatelet is illustrated through the Y axis.

Preferably, the lateral size of the nanoparticles is between 20 and 55 μm and more preferably between 30 and 55 μm.

Preferably, the thickness of the coating is between 10 and 250 μm. For example, the thickness of the coating is between 10 and 100 μm or between 100 and 250 μm.

Preferably, the coating further comprises an organometallic compound. For example, the organometallic compound includes Dipropylene glycol monomethyl ether (CH₃OC₃H₆OC₃H₆OH), 1,2-Ethanediol (HOCH₂CH₂OH) and 2-ethylhexanoic acid, manganese salt (C₈H₁₆MnO₂). Indeed, without willing to be bound by any theory, it is believed that the organometallic compound allows for a fast curing of the coating avoiding a drying step at high temperature.

Advantageously, the steel substrate is a slab, a billet or a bloom.

The invention also relates to a method for the manufacture of the coated steel substrate according to the present invention, comprising the successive following steps:
A. The provision of a steel substrate having the above steel composition,
B. The coating deposition using an aqueous mixture to form the coating,
C. Optionally, the drying of the coated steel substrate obtained in step B).

Preferably, in step B), the deposition of the coating is performed by spin coating, spray coating, dip coating or brush coating.

Advantageously, in step B), the aqueous mixture comprises from 1 to 60 g/L of nanographite and from 150 to 250 g/L of binder. More preferably, the aqueous mixture comprises from 1 to 35 g/L of nanographite.

Preferably, in step B), wherein the aqueous mixture comprises nanographite comprising above 95% and advantageously 99% by weight of C.

Advantageously, in step B), the ratio in weight of nanographite with respect to binder is below or equal to 0.3.

Preferably, in step B), the aqueous mixture comprises an organometallic compound. More preferably, the concentration of the organometallic compound is equal or below to 0.12 wt. %. Indeed, without willing to be bound by any theory, it is believed that this concentration allows for an optimized coating without any curing or with a curing at room temperature.

In a preferred embodiment, the coating is dried in a step C). Without willing to be bound by any theory, it is believed that the drying step allows for an improvement of the coating adhesion. Indeed, since water evaporates, the binder becomes tackier and more viscous leading to a hardened condition. In a preferred embodiment, in step C), the drying is performed at room temperature or at a temperature between 50 and 150° C. and preferably between 80 and 120° C.

In another preferred embodiment, no drying step is performed.

Preferably, in step C), when a drying is applied, the drying step is performed with hot air.

Advantageously, in step C), when a drying is applied, the drying is performed during 5 to 60 minutes and for example, between 15 and 45 minutes.

The invention also relates to a method for manufacture of a Hot rolled steel product comprising the following successive steps:
I. The provision of the coated steel substrate according to the present invention,
II. The reheating of the coated steel substrate in a reheating furnace at a temperature between 750 and 1300° C.,
III. The descaling of the reheated coated steel sheet obtained in step II) and
IV. The hot-rolling of the descaled steel product.

Preferably, in step II), the reheating is performed at a temperature between 750 and 900° C. or between 900 and 1300° C.

Preferably, in step III), the descaling is performed using water under pressure. For example, the water pressure is between 100 and 150 bars. In another embodiment, the descaling is performed mechanically, for example, by scratching or brushing the scale layer.

With the method according to the present invention, a hot rolled steel product having a high weight mass is obtained compared to the prior art.

For example, after the hot-rolling, the hot product can be coiled, cold-rolled, annealed in an annealing furnace and also coated with a metallic coating.

Finally, the invention relates to the use of a hot rolled steel product obtainable from the method according to the present invention for the manufacture of a part of an automotive vehicle, a rail, a wire or a spring.

The invention will now be explained in trials carried out for information only. They are not limiting.

### EXAMPLES

In Examples, steels substrates having the following steel composition in weight percent were used:

| Steel | C | Mn | Si | Cu | Cr | Ti | V | Mo | Ni |
|---|---|---|---|---|---|---|---|---|---|
| 1 | 0.798 | 1.310 | 0.446 | 0.014 | 0.097 | 0.0014 | 0.0026 | 0.0018 | 0.016 |
| 2 | 0.39 | 0.673 | 1.593 | 0.011 | 0.036 | 0.003 | 0.002 | 0.001 | 0.014 |
| 3 | 0.901 | 0.309 | 0.244 | 0.017 | 0.215 | 0.002 | 0.002 | 0.001 | 0.019 |

Trial 2 was casted in the form of slab and Trials 1 and 3 were casted in the form of billet.

### Example 1: Adhesion Test

In this test, different aqueous mixtures comprising nanographites and a binder were deposited on Steel 2. The aqueous mixture was sprayed on Steel 2. Then, the coating was dried during 30 minutes at 100° C. The suspension of the aqueous solution was evaluated by visual inspection and the coating adhesion was evaluated by optical microscopy to check the homogeneity in thickness and also in terms of coverage. Results are in the following Table 1:

| | Aqueous mixture | | | | |
|---|---|---|---|---|---|
| Aqueous | | Binder | Additive in | | Coating |
| mixtures | Nanographite | (200 g/L) | the binder | Suspension | adhesion |
| 1* | Lateral size: | Na₂SiO₃ | — | High | High |
| | 35-50 μm, | (sodium | | stability and | adhesion |
| | 30 g/L | silicate) | | sprayability | (coverage |
| | | | | | 100%) |
| 2 | Lateral size: | Al₂(SO₄)₃ | — | High | No |
| | 35-50 μm, | (aluminum | | stability | adhesion |
| | 30 g/L | sulfate) | | | (coverage |
| | | | | | 0%) |
| 3 | Lateral size: | AlPO₄ | — | High | No |
| | 35-50 μm, | (aluminum | | stability | adhesion |
| | 30 g/L | phosphate) | | | (coverage |
| | | | | | 0%) |
| 4 | Lateral size: | Na₂SiO₃ | MgO | Low | High |
| | 35-50 μm, | | (50 g/L) | stability and | adhesion |
| | 30 g/L | | | good | (% |
| | | | | sprayability | coverage: |
| | | | | | 100) |
| 5 | Lateral size: | Al₂(SO₄)₃ | MgO | Formation | No |
| | 35-50 μm, | | (50 g/L) | of slurry, | sprayability |
| | 30 g/L | | | high | so not |
| | | | | viscosity | coating |
| | | | | | was |
| | | | | | obtained |
| 6* | Lateral size: | Al₂(SO₄)₃ | Al₂O₃ | High | High |
| | 35-50 μm, | | (50 g/L) | stability and | adhesion |
| | 30 g/L | | | sprayability | (% |
| | | | | | coverage |
| | | | | | 100%) |
| 7 | Lateral size: | Al₂(SO₄)₃ | MgO | Formation | No |
| | 35-50 μm, | | (50 g/L) + | of slurry, | sprayability |
| | 30 g/L | | Al₂O₃ | high | so not |
| | | | (50 g/L) | viscosity | coating |
| | | | | | was |
| | | | | | obtained |
| 8 | Lateral size: | AlPO₄ | MgO | Very Low | Bad |
| | 35-50 μm, | | (50 g/L) | stability | adhesion |
| | 30 g/L | | | | (% |
| | | | | | coverage: |
| | | | | | 20) |
| 9 | Lateral size: | AlPO₄ | Al₂O₃ | Very Low | Bad |
| | 35-50 μm, | | (50 g/L) | stability | adhesion |
| | 30 g/L | | | | (% |
| | | | | | coverage: |
| | | | | | 10) |
| 10 | Lateral size: | AlPO₄ | MgO | Very Low | Bad |
| | 35-50 μm, | | (50 g/L) + | stability | adhesion |
| | 30 g/L | | Al₂O₃ | | (% |
| | | | (50 g/L) | | coverage: |
| | | | | | 15) |

*according to the present invention

Trials 1 and 6 according to the present invention have a high stability and sprayability, i.e. can easily be sprayed, and a high adhesion on the steel substrate.

### Example 2: Oxidation Test

For Trials 1, 3, 5 and 7, steels 2 and 3 were coated by spraying Aqueous mixture 1 or 6 of Example 1 onto the steel. Then, the coating was dried during 30 minutes at 100° C.

Then, uncoated steels (Trials 2, 4, 6 and 8) and coated steels (Trials 1, 3, 5 and 7) were reheated at 800° C. and 1000° C. After the reheating, all the trials were weighted. For each Trial, Δweight was determined by subtracting the weight after reheating from the weight before the reheating. The percentage of weight gain of the coated Trial was then calculated with the following formula:

$$weight gain ( \% ) = 100 - ( \frac{Δ weight of coated trial \times 100}{Δ weight of uncoated trial} ) .$$

The results are in the following Table 2:

| | | | Reheating step | | Δ | Weight |
|---|---|---|---|---|---|---|
| | | | temperature | | Weight | gain |
| Trials | Steels | Coating | (° C.) | time | (g) | (%) |
| 1* | 2 | Aqueous | 800 | 3 h 20 min | 0.72 | 25 |
| | | mixture 1 | | | | |
| 2 | 2 | — | 800 | 3 h 20 min | 0.96 | |
| 3* | 2 | Aqueous | 1000 | 3 h 20 min | 6.3 | 23 |
| | | mixture 1 | | | | |
| 4 | 2 | — | 1000 | 3 h 20 min | 8.2 | |
| 5* | 3 | Aqueous | 800 | 1 h 15 min | 0.17 | 43 |
| | | mixture 1 | | | | |
| 6 | 3 | — | 800 | 1 h 15 min | 0.3 | |
| 7* | 3 | Aqueous | 1000 | 3 h 20 min | 4.8 | 19 |
| | | mixture 1 | | | | |
| 8 | 3 | — | 1000 | 3 h 20 min | 5.9 | |

*according to the present invention.

Trials according to the present invention show a significant increase of the percentage of weight gain. Indeed, the steel substrate having the specific steel composition according to the present invention is well protected with the aqueous mixture 1 and 6 during the reheating step.

### Example 3: Decarburization Test

For Trials 9, 10, 12, 13, 14, 15 and 17, steel 1 or 2 was coated by spraying Aqueous mixture 1 of Example 1 onto the steel. Then, optionally, the coating was dried at room temperature or during 30 minutes at 100° C.

Then, uncoated steels (Trials 11, 16 and 18) and coated steels (Trials 9, 10, 12, 13, 14, 15 and 17) were reheated at 1250° C. After the reheating, the trials were analyzed by optical microscopy (OM). 0 means that almost no decarburized areas are present at the trial surface, i.e. almost no decarburization happened, during the reheating and 1 means that a lot of decarburized areas are present at the surface of the trial.

The results are in the following Table 3:

| | | | Curing after | Reheating step | | |
|---|---|---|---|---|---|---|
| | | | coating | temperature | | decarbu- |
| Trials | Steels | Coating | deposition | (° C.) | time | rization |
| 9* | 2 | Aqueous | 30 min at | 1250 | 3 h | 0 |
| | | mixture 1 | 100° C. | | | |
| 10* | 2 | Aqueous | 30 min at | 1250 | 6 h | 0 |
| | | mixture 1 | 100° C. | | | |
| 11 | 2 | — | — | 1250 | 3 h | 1 |
| 12* | 1 | Aqueous | 30 min at | 1250 | 2 h | 0 |
| | | mixture 1 | 100° C. | | | |
| 13* | 1 | Aqueous | 30 min at | 1250 | 6 h | 0 |
| | | mixture 1 | 100° C. | | | |
| 14* | 1 | Aqueous | No curing | 1250 | 6 h | 0 |
| | | mixture 1 | | | | |
| | | including | | | | |
| | | DriCAT ® | | | | |
| 15* | 1 | Aqueous | Room | 1250 | 6 h | 0 |
| | | mixture 1 | temperature | | | |
| | | including | | | | |
| | | DriCAT ® | | | | |
| 16 | 1 | — | — | 1250 | 2 h | 1 |
| 17* | 1 | Aqueous | 30 min at | 1250 | 3 h | 0 |
| | | mixture 1 | 100° C. | | | |
| 18 | 1 | — | — | 1250 | 3 h | 1 |

*according to the present invention.

For Trials according to the present invention, a very low amount of carbon was removed at the trial surface. On the contrary, for comparative Trials, a lot of decarburized areas were present allowing a change in the microstructure and therefore mechanical properties. Indeed, in the areas where there is a lot of carbon depletion, i.e. decarburized areas, ferrite is formed instead of pearlite.

### Example 4: Microhardness Test

In this case, after the reheating at 1250° C., some Trials were quenched in water to form martensite and the microhardness evolution from the hot steel product surface to a depth of 1500 μm was determined by microhardness measurements. Indeed, when martensite is formed, the carbon content of the martensite is directly proportional to the amount of carbon in the microstructure. Therefore, the higher the microhardness is, the higher the carbon content is.

The results are in the following Table 4:

| | | | Reheating step | | Microhardness (HV) | | | |
|---|---|---|---|---|---|---|---|---|
| | | | temperature | | 100 | 500 | 1000 | 1500 |
| Trials | Steel | Coating | (° C.) | time | (μm) | (μm) | (μm) | (μm) |
| 12* | 1 | Aqueous | 1250 | 2 h | 840 | 840 | 840 | 840 |
| | | mixture 1 | | | | | | |
| 16 | 1 | — | 1250 | 2 h | 280 | 420 | 600 | 700 |
| 17* | 1 | Aqueous | 1250 | 3 h | 820 | 840 | 900 | 900 |
| | | mixture 1 | | | | | | |
| 18 | 1 | — | 1250 | 3 h | 380 | 640 | 820 | 900 |

*according to the present invention.

The microhardness of Trials 12 and 17 clearly show that the decarburization was significantly reduced with the coated steel substrate according to the present invention compared to Trials 16 and 18.

1-23. (canceled)

24. A coated steel substrate comprising:
a steel substrate;
a coating including nanographite flakes having a lateral size between 1 and 60 μm; and
a binder including sodium silicate or a binder including aluminum sulfate and an additive being alumina, wherein the steel substrate has a composition in weight percent as follows:
0.31≤C≤1.2%,
0.1≤Si≤1.7%,
0.15≤Mn≤3.0%,
P≤0.01%,
S≤0.1%,
Cr≤1.0%,
Ni≤1.0%,
Mo≤0.1%,
and on a purely optional basis, at least one of the following:
Nb≤0.05%,
B≤0.003%,
Ti≤0.06%,
Cu≤0.1%,
Co≤0.1%,
N≤0.01%,
V≤0.05%,
a remainder of the composition being made of iron and inevitable impurities resulting from processing.

25. The coated steel substrate as recited in claim 24 wherein the lateral size of the nanoparticles is between 20 and 55 μm.

26. The coated steel substrate as recited in claim 25 wherein the lateral size of the nanoparticles is between 30 and 55 μm.

27. The coated steel substrate as recited in claim 24 wherein a thickness of the coating is between 10 and 250 μm.

28. The coated steel substrate as recited in claim 24 wherein the coating further comprises an organometallic compound.

29. The coated steel substrate as recited in claim 28 wherein the organometallic compound includes Dipropylene glycol monomethyl ether (CH₃OC₃H₆OC₃H₆OH), 1,2-Ethanediol (HOCH₂CH₂OH) and 2-ethylhexanoic acid, manganese salt (C₈H₁₆MnO₂).

30. The coated steel substrate as recited in claim 24 wherein the steel substrate is a slab, a billet or a bloom.

31. A method for the manufacture of the coated steel substrate as recited in claim 24, the method comprising the successive following steps:
providing the steel substrate; and
depositing an aqueous mixture on the steel substrate to form the coating.

32. The method as recited in claim 31 further comprising drying of the coating.

33. The method as recited in claim 31 wherein the depositing is performed by spin coating, spray coating, dip coating or brush coating.

34. The method as recited in claim 31 wherein the aqueous mixture includes from 1 to 60 g/L of nanographite and from 150 to 250 g/L of binder.

35. The method as recited in claim 31 wherein the aqueous mixture includes nanographite with above 95% by weight of C.

36. The method as recited in claim 35 wherein the aqueous mixture includes an amount of C equal or above to 99% by weight.

37. The method as recited in claim 31 wherein a ratio in weight of nanographite with respect to binder is below or equal to 0.3.

38. The method as recited in claim 31 wherein the aqueous mixture includes an organometallic compound.

38. The method as recited in claim 38 wherein a concentration of the organometallic compound is equal or below to 0.12 wt. %.

39. The method as recited in claim 32 wherein the drying is performed at a temperature between 50 and 150° C.

40. The method as recited in claim 32 wherein the drying is performed at room temperature.

41. The method as recited in claim 32 wherein the drying is performed with hot air.

42. The method as recited in claim 32 wherein the drying is performed for 5 to 60 minutes.

43. A method for manufacture of a hot rolled steel product, the method comprising the following successive steps:
providing the coated steel substrate as recited in claim 24;
reheating the coated steel substrate in a reheating furnace at a temperature between 750 and 1300° C.;
descaling of the reheated coated steel sheet; and
hot-rolling the descaled steel product.

44. The method as recited in claim 43 wherein the reheating is performed at a temperature between 800 and 1300° C.

45. The method as recited in claim 43 wherein the descaling is performed using water under pressure or the descaling is performed mechanically.

46. The method as recited in claim 43 wherein the descaling is performed using the water under pressure, the pressure being between 100 and 150 bars.
